(19) United States
(12) Patent Application Publication
(10) Pub. No.: US 2002/0184776 A1
(43) Pub. Date: Dec. 12, 2002

(54) Jak measuring system and method of use

(76) Inventor: John Anthony Karageorge, Ocean City, MD (US)

Correspondence Address: CLARK & BRODY, Suite 600, 1750 K Street, NW, Washington, DC, 20006, US

(21) Appl. No.: 09/986,565

(22) Filed: Nov. 9, 2001

Related U.S. Application Data
(60) Provisional application No. 60/287,709, filed on May 2, 2001.

(51) Int. Cl. G01B 3/02

(52) U.S. Cl. 33/494

(57) ABSTRACT

A measuring system uses light seconds as it base measurement, and particularly defines a new foot as one billionth of a light second. Based on a speed of light of 186,282.3970512 current miles per light second, a new foot of the measuring system equals 11.80285267716 conventional inches. The system also defines 10 new inches as a new foot, and a new inch would equal 1.180285267716 old inches or one tenth of a new foot. A new mile would equal 5,000 new feet. A ratio of 1.5 is used to convert to new metric units so that a new kilometer is 1.5 times a new mile.

This patent application claims priority based on provisional patent application No. 60/287,709, filed on May 2, 2001.

### FIELD OF THE INVENTION

The present invention is directed to a measuring system, and in particular to a measuring system that uses the speed of light in terms of a light second as a base unit.

### BACKGROUND ART

In the present day systems, either the US system or the metric system, conversion calculations can be cumbersome and error prone due to the continued occurrence of decimals, or fractions. Inches are not easily converted to centimeters, and vice versa. FIG. 1 shows a conventional ruler 1 with 12 gradations 3, each representing 1 inch.

Consequently, there is a need for improved measuring systems that overcome the deficiencies existing in the systems commonly used today.

The present invention solves this problem by providing a measuring system that is based on the speed of light, particularly, light seconds. The inventive system makes it easier to convert between a linear system, and a metric system.

### SUMMARY OF THE INVENTION

It is a first object of the present invention to provide an improved measuring system.

Another object of the invention is to provide a measuring system that makes it much easier to convert between linear and metric units.

Still another object of the invention is a ruler made of gradations based on the new measuring system.

Other objects and advantages of the present invention will become apparent as a description thereof proceeds.

In satisfaction of the foregoing objects and advantages, the present invention provides a new measuring system that uses as its basis the distance light travels in a second. The measuring system employs a first set of standard gradations spaced along a length thereof, each gradation being based on a multiple of a light second, wherein the light second is based on the distance light travels over a year time period. The standard gradation is called a new inch, with 10 new inches making up a new foot, and 5,000 new feet making up a new mile. A new foot is based on 1 billionth of a light second.

The measuring system also includes a second set of metric gradations representing a metric system. The metric system is based on 2/3 ratio of the new kilometer to the new mile. Thus, taking into account the difference in the new foot, and new mile, a new centimeter equals 0.3333333 new inches. More particularly, with the metric gradation as a new kilometer, the standard gradation as a new mile, and the ratio, 0.666666666 new miles equal a new kilometer.

The system can be used in a ruler form, tape measure, or any other means for measuring or recording distances, such as computers, etc. A ruler using the new system could depict 10 new inches on one side as a new foot, with the corresponding millimeters, centimeters, etc. on the other side.

The system can be compared to the conventional system wherein a new foot equals 11.80285267716 old inches, and 10 new inches equal a new foot, and 5,000 new feet equal a new mile.

The invention includes a method of measuring distance between two points wherein the measurement standard uses a fraction of a light second. For example, a new foot is based on one billionth of a light second. Then, other standards can be used based on the new foot, e.g., 10 new inches/new foot, and 5,000 new feet/new mile. The invention also contemplates measuring distances using the new gradations. That is, an old mile of 5,280 old feet can be walked off in new feet, such that the old mile would be 5,368.193752226 new feet. The new mile would be equal to 4,917.855282152 old feet. (New mile=5,000 new feet.)

### BRIEF DESCRIPTION OF THE DRAWINGS

Reference is now made to the drawings of the invention wherein:

FIG. 1 shows a prior art ruler using the conventional US linear measurements and the metric system measurements; and

FIG. 2 shows a rule showing gradations reflecting the new measurement systems.

### DESCRIPTION OF THE PREFERRED EMBODIMENTS

The present invention offers significant advantages over the conventional US linear and metric measuring systems. Conversion between these two systems can be cumbersome, with decimals or fractions often resulting. The present invention offers a much simpler measuring system that employs as its base unit light seconds.

Since it is now possible to accurately compute the exact speed of light using laser beams and atomic clocks, the prior art measuring system and tools can be recalibrated in accordance with a universal standard, the speed of light.

Providing this new measuring system may make it easier in the future with respect to deep space operations and the like. Conversions for the likes of astronomers, mathematicians, scientists, etc. will be made much easier.

Under the current system, there are 299,792.458 old kilometers per light second, and 186,282.3970512 old miles per light second (a second is based on 1/86,400^{th} of the earth's daily rotation.)

The following recalibrates the conventional measuring systems so that 300,000 new kilometers per light second equals 200,000 new miles per light second. The system also changes the US linear system to align with a decimal base 10 system by using 10 new inches per new foot, and 5,000 new feet per mile. In the new measurement system, there would be 1,000,000,000 new feet per light second.

The speed of light is 186,282.3970512 old miles per second, and 983,571,056.4303 old feet per second using 5,280 old feet per mile. Dividing 983,571,056.4303 old feet per second by 1,000,000,000 new feet per light second gives a percentage of 98.35710564303. Thus, a new foot is this percentage of an old foot, or 1.64289435697% shorter than an old foot. The new foot is 0.9835710564303×12 inches or 11.80285267716 old inches. Hereinafter, conventional measurements will be classified as “old”, with the new measurement system using the term, “new”.

Using 10 inches per new foot, the new inch is 1.180285267716 of the old inches, or the new inch is 18.0285267716% larger. The new inch can also be further divided into ½, ¼, ⅛, 1/16, 1/32, etc, and ⅕, 1/10, 1/20, etc. as well.

When going to the new metric system, the length of the old kilometer is 3,280.839895013 old feet. Under the new system of 300,000 new kilometers per light second and 200,000 new miles per light second (5,000 new feet per mile), the new kilometer would be 3,278.570188101 old feet long and 3,333.333 new feet long. The new metric system would also encompass 33.333 waves per centimeter (100 waves per inch where molecules start resonating or vibrating.) This makes the conversion calculations from measurements in light seconds to measurements in miles and kilometers much easier.

The current ratio of kilometer to mile is 1.609344 kilometers per mile vs. 0.6213711922373 miles per kilometer. At 25.4 millimeters per old inch×12 old inches, ×5,280 old feet per old mile, there are 1,609,344 millimeters per mile/1,000,000 mm per kilometer equals 1.609344 kilometers per mile. 1 mile/1.609344 equals 0.6213711922373 miles per kilometer.

A further verification of the old ratios entails substituting 186,282.3970512 miles per second for one US unit, and 299,792.458 kilometers per light second for one metric unit, the ratio is 0.6213711922373.

The new kilometer and new mile calculate as follows:

186,282.3970512 miles/200,000=0.931411985256. (the new mile is 6.8588014744% smaller than the old mile.

299,792.458/300,000=0.999308193333.(the new millimeter, centimeter, and kilometer are 0.0691807% smaller than the old ones.

200,000/300,000=0.6666666666666666 new miles per new kilometer, or 1/0.666666666666666=1.5 new kilometer per new mile.

The new inch is 18.0285267716% larger than the old inch (1.180285267716×25.4 old mm per inch 29.9792458 old millimeters per new inch.

29.9792458 old mm per new inch/0.999308193333 old mm per new mm=30 new mm per new inch as opposed to 25.4 mm per inch (old system).

30.0 mm per new inch×10 new inches per new foot×5000 new foot per new mile=1,500,000 new mm per new mile/1,000,000 mm=1.5 kilometers per new mile, or 0.66666666 new miles per new kilometer.

The following table summarizes the various measurements under the inventive system.

| Linear System | | Metric System | |
|---|---|---|---|
| 1 New Inch | =30 new mm | 1 New mm | =0.03333333 |
| | =3.0 new cm | | new inch |
| | =0.03 new m | | |
| | =1/10 | | |
| | billionth of a | | |
| | light second | | |
| 1 New Foot | =300 new mm | 1 New cm | =10 new mm |
| | =30.0 new cm | | 0.333333 new |
| | =0.3 new in | | inches |
| | =.333333 new | | |
| | yards | 1 New dm | =3.3333 new |
| | =10 new inches | | inches or |
| | =1 billionth | | 10 new cm |
| | of a light | | |
| | second | | |
| 1 New Yard | =900 new mm | 1 New | =1,000 new |
| | =90 new cm | Kilometer | meter |
| | =.9 new m | | =3,333.333 new |
| | =30 new | | feet |
| | inches | | =0.6666666 new |
| | =3 new feet | | miles |
| | | | =1/300,000^{th} of |
| | | | a light second |
| 1 New Mile | =50,000 new | 1 New meter | =1,000 new mm |
| | inches | | 100 new cm |
| | =5,000 new | | =33.3333333 |
| | feet | | new inches |
| | =1.5 | | =3.3333333 new |
| | kilometers | | feet |
| | =1/200,000 of | | =1.1111111 new |
| | a light second | | yards |
| | | 1 New | =10 new |
| | | decameter | meters |
| | | 1 New | =100 new |
| | | hectometer | meters |
| | | 1 New | =10,000 new |
| | | myriameter | meters |

The table more clearly shows that the new foot is based on 1,000,000,000 of a light second, 10 new inches make a foot, and 5,000 new feet make a new mile. Similarly, it can be said that a new kilometer is ⅔ of a new mile.

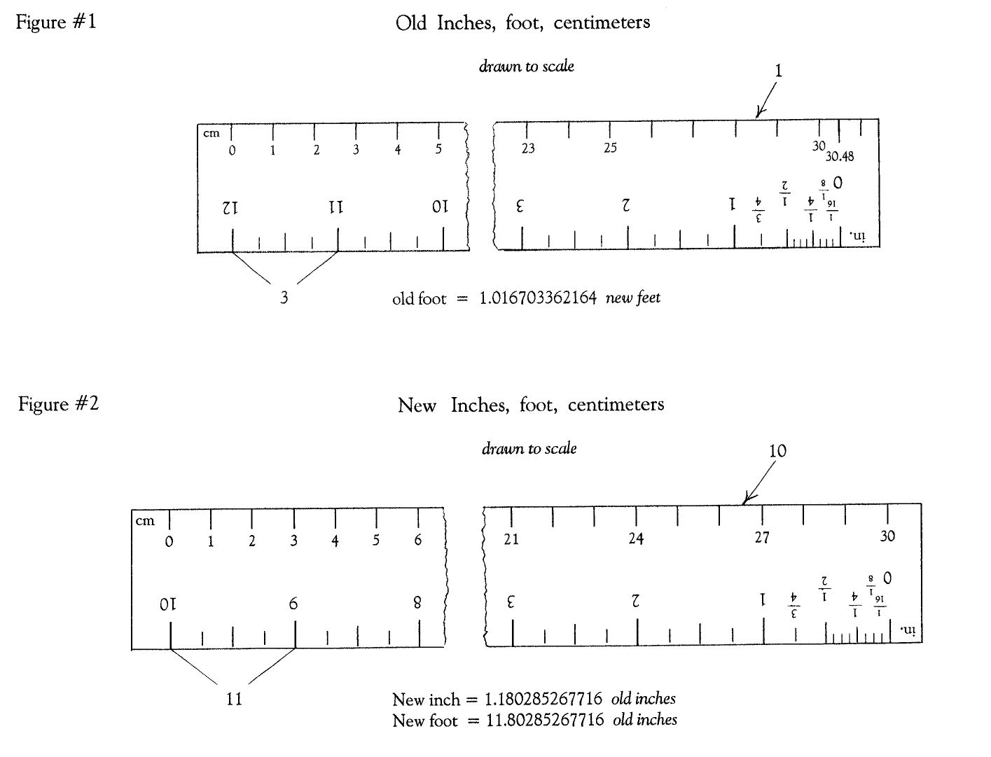

Referring now to FIG. 2, a ruler 10 is depicted with 10 gradations 11, each gradation reflecting a new inch. Compared to the inches and foot of FIG. 1, it can be readily seen that the new foot is slightly smaller than the old foot, but that the new inch is larger than the old inch since only 10 new inches are in a new foot. The ruler 10 also depicts the new metric gradations, wherein 30 new millimeters equals one new inch, and one new foot would equal 300 millimeters. Although not depicted, the new mile would be shorter than the old mile, since 5000 new feet are in a new mile, and new feet are only 11.80285267716 old inches.

In its broadest embodiment, the invention comprises a measurement system having a number of gradations, wherein the gradations are based on light seconds. More particularly, the new foot is one billionth of a light second, and the metric system is based on a 3/2 ratio wherein 1.5 new kilometers equals 1.0 new mile.

While a ruler is depicted, any known means can be employed with the new gradations, tape measures, straight edges, carpenter squares, protractors, folding rulers, and the like. Electronic devices can be programmed to sense the new gradations, and display the same. Other electronic devices and software can also employ the measurement system such that the measurement system would be depicted in displays, printouts, messages, etc.

As such, an invention has been disclosed in terms of preferred embodiments thereof which fulfills each and every one of the objects of the present invention as set forth above and provides a new and improved measuring system.

Of course, various changes, modifications and alterations from the teachings of the present invention may be contemplated by those skilled in the art without departing from the intended spirit and scope thereof. It is intended that the present invention only be limited by the terms of the appended claims.

What is claimed is:

1. A measuring system having a first set of standard gradations spaced along a length thereof, each gradation being based on a multiple of a light second, wherein the light second is based on a light year.

2. The system of claim 1, wherein the standard gradation is a new inch, 10 new inches making up a new foot, and 5,000 new feet making up a new mile, and a new foot is based on 1 billionth of a light second.

3. The system of claim 2 including a second set of metric gradations representing a metric system, wherein a metric gradation from the second set includes one of a centimeter, wherein one centimeter equals 0.3333333 new inches, a millimeter wherein one millimeter equals 0.03333333 new inches, and one kilometer wherein one kilometer equals 3,333,333 new feet.

4. The system of claim 2, wherein three new centimeters equal one new inch.

5. The system of claim 2, wherein 1.5 new kilometers equal a new mile.

6. The system of claim 1, comprising a ruler having the first set of gradations thereon.

7. The system of claim 3, comprising a ruler having new inches on one edge, and one of new millimeters or new centimeters on another edge.

8. The system of claim 1 wherein a new foot equals 11.80285267716 old inches, 10 new inches equal a new foot, and 5,000 new feet equal a new mile.

9. The system of claim 1, wherein the gradations are on one of a tape measure, a straightedge, a foldable measuring device, or are incorporated into electronic devices and their software.

10. A method of measuring a distance between two points wherein the measurement standard employs a fraction of a light second.

11. The method of claim 10, wherein the measurement standard is a billionth of a light second for each new foot.
